(19) United States
(12) Patent Application Publication
(10) Pub. No.: US 2016/0052028 A1
(43) Pub. Date: Feb. 25, 2016

(54) DISPENSE TIP CLEANING APPARATUS

(71) Applicant: Henkel IP & Holding GmbH, Duesseldorf (DE)

(72) Inventors: John Breault, New Britain, CT (US); Karl Gabrielson, Burlington, CT (US)

(21) Appl. No.: 14/870,762

(22) Filed: Sep. 30, 2015

Related U.S. Application Data
(63) Continuation of application No. PCT/US2014/033307, filed on Apr. 8, 2014.
(60) Provisional application No. 61/809,633, filed on Apr. 8, 2013.

(51) Int. Cl. B08B 5/02

(52) U.S. Cl. CPC B08B 5/02

(57) ABSTRACT

A dispense tip cleaning apparatus that includes a cannular plate, a hub plate, a needle hub locator, a dispense tip and a retainer.

### FIELD OF THE INVENTION

The present invention is an apparatus for cleaning a dispense tip that is used to apply an adhesive material to a surface. In particular, the present invention relates to an apparatus for continuously cleaning a dispense tip in an automated process that applies a predetermined volume of adhesive material to a surface accurately and repeatedly.

### BACKGROUND OF INVENTION

Dispensing adhesives onto surfaces using a dispense nozzle is difficult because of the characteristics of the adhesives, in particular the low viscosity and the tendency for the adhesive to cure on/in the tip of the nozzle. Over time, a build-up of cured adhesive on the tip of the nozzle affects the dispensing operation and causes decreased amounts of adhesive to be deposited on the surface. Various attempts have been made to remove cured adhesive that may build up on the tip of a dispensing nozzle but none has been found to solve the problem.

Some of the prior art methods use a sponge, tissue or some other type of article to wipe the tip of the dispense nozzle. However, this causes problems in a manufacturing process because the sponge needs to be replaced. The sponge also can transfer contaminants onto the dispense tip that cause the adhesive to cure more rapidly. In addition, repeatedly contacting the tip can change the position of the tip so that it does not deposit the adhesive at the desired location. When the dispense nozzle is a small needle, repeated contact wiping can damage it.

Other methods in the prior art use a “wire fence” to clean the dispense tip. The wire fence is a small diameter wire that is stretched between two points perpendicular to the dispense tip. The dispense tip is moved across the wire and adhesive drops are “knocked off” the end of the dispense tip. These methods have several drawbacks including frequent cleaning of the wire and changing volume of the dispensed adhesive caused by the wire pulling adhesive out of the cannular. As used herein, the term “cannular” refers to an elongate tubular structure and is used interchangeably with the terms needle and tip. The wire fence methods also require increased maintenance. For example, the wire height must be checked with each dispense tip change.

Attempts have also been made to prevent the build-up of adhesive by the direct air blow-off of the dispense tip. However, the air is directed to only one side of the cannular and not the entire perimeter so that all of the adhesive is not cleaned off the dispense tip. In order to clean the cylindrical surface of the tip, direct air blow off must be aimed and the movement controlled to cover the entire cylindrical surface. Moreover, in direct air blow off methods, the air hits only , one side of the nozzle and can change the position of the dispense tip.

A clean dispense tip is needed for the precise deposition of adhesive drops and beads on a surface and to control the accurately control the volume of the dose. Any built-up adhesive or debris at the end of a dispense tip can cause premature curing and change the flow of the adhesive. Maintaining a clean dispense tip improves the control of adhesive dispensing in a fully automated environment. However, the many existing methods for repeatedly cleaning a dispense tip in an automated operation require high maintenance and frequent adjustments. Accordingly, there is a need for a dispense tip cleaning apparatus that requires minimal maintenance and prevents the build-up of adhesive without contacting the tip.

### SUMMARY OF THE INVENTION

In accordance with the present invention, a dispense tip cleaning apparatus is provided. In a first embodiment, he dispense tip cleaning apparatus includes: a cannular plate, a hub plate, a needle hub locator, a dispense tip and a retainer. The cannular plate has a base plate with a top surface and a bottom surface, a first section with a side wall that extends from the bottom surface, a second section that extends from the first section to a bottom wall with a bottom aperture extending therethrough. An opening in the top surface of the base plate extends through the first and second sections to the bottom wall. The opening defines an interior with an interior wall. Preferably, the opening in the cannular plate has a first diameter in the base plate, a second diameter in the first section and a third diameter in the second section. The first diameter is greater than the second diameter and the second diameter is greater than the third diameter. An aperture extends through the side wall of the first section into the interior.

The hub plate has a cylindrical side wall with a flanged end, a distal end and a passage extending therebetween. The distal end of the hub plate preferably has an inwardly extending lip and the flanged end of the hub plate is preferably beveled. The flanged end of the hub plate has a diameter less than the first diameter and greater than the second diameter of the opening in the cannular plate. The hub plate is inserted in the opening in the cannular plate and the flanged end contacts the second section of the cannular plate but does not pass into the second section. This forms a chamber between the cylindrical side wall of the hub plate and the interior wall of the cannular plate. In addition, the distal end and the bottom wall of the cannular plate form a ring nozzle around the bottom aperture in the second section of the cannular plate.

The needle hub locator has a cylindrically shaped body with an axial bore and a plurality of apertures extending between a first and a second side. Preferably, the plurality of apertures in the needle hub locator is substantially parallel to the axial bore. The needle hub locator is inserted in the opening in the cannular plate and on top of the hub plate.

The dispense tip has an elongate body with first and second ends and a hollow needle extending from the second end of the body. The dispense tip is inserted through the axial bore of the needle hub locator and the passage in the hub plate until the hollow needle extends through the bottom aperture in the cannular plate. The aperture in the cannular plate is adapted to transmit compressed air into the chamber and through the ring nozzle around the bottom aperture and needle. The air flow prevents adhesive from building up on the needle.

The retainer secures the needle hub locator in the cannular plate. Preferably, the retainer has a flexible open ring structure. The interior wall of the body of the cannular plate can have a groove that is engaged by the retainer to lock it in place. When pressure is applied to the ends of the retainer, the diameter decreases and it can be removed from the groove.

In a further embodiment, the dispense tip cleaning apparatus includes a Coanda plate and a cap plate. The Coanda plate has a perimetrical wall with at last one aperture, preferably two apertures that can be threaded, and a top surface and a bottom surface with an opening extending therebetween. The Coanda plate can include one or more passages that extend from each aperture in the perimetrical wall to the top surface. The Coanda plate can also include an interior wall that defines the opening and a lip that extends inwardly from the interior wall to form a discharge aperture.

The cap plate has a top surface, a bottom surface, an exterior side wall and an annular member with an axial bore extending from the bottom surface to a distal end. The cap plate can also have a recessed portion in the bottom surface extending radially from the annular member.

The top surface of the Coanda plate is disposed opposite the bottom surface of the cap plate and the annular member is positioned in the opening in the Coanda plate and forms an annular chamber bounded by the interior wall of the Coanda plate. Preferably, the distal end of the annular member and the discharge aperture form a ring nozzle for discharging high pressure air. The annular chamber is in fluidic communication with the at least one aperture in the perimetrical wall of the Coanda plate, preferably, via the recessed portion in the cap plate. The axial bore and opening are adapted for receiving a dispense tip and the aperture in the Coanda plate is adapted to transmit compressed air into the annular chamber, through the ring nozzle and around the dispense tip to clean the dispense tip.

The dispense tip cleaning apparatus can also include a gasket disposed between the bottom surface of the cap plate and the top surface of the Coanda plate for sealingly joining them. The Coanda plate can have one or more apertures and the hub plate can have one or more apertures that are correspondingly located and aligned so that the cap plate can be secured to the Coanda plate with one or more fastening devices.

### BRIEF DESCRIPTION OF THE FIGURES

The preferred embodiments of the dispense tip cleaning apparatus of the present invention, as well as other objects, features and advantages of this invention, will be apparent from the accompanying drawings wherein:

FIG. 1 is an exploded view of a first embodiment of the dispense tip cleaning apparatus of the present invention.

FIG. 2 is a bottom perspective view of the first embodiment of the dispense tip cleaning apparatus shown in FIG. 1 with the dispense tip extending from the bottom of the cannular plate.

FIG. 3 is a top perspective view of the first embodiment of the dispense tip cleaning apparatus shown in FIG. 1.

FIG. 4 is a perspective view of the first embodiment of the dispense tip cleaning apparatus shown in FIG. 1.

FIG. 5 is a sectional view A-A of the first embodiment of the dispense tip cleaning apparatus shown in FIG. 4.

FIG. 6A is a perspective view of the cannular plate of the first embodiment of the dispense tip cleaning apparatus shown in FIG. 1.

FIG. 6B is a rear view of the cannular plate shown in FIG. 6A.

FIG. 6C is a top view of the cannular plate shown in FIG. 6A

FIG. 6D is a side view of the cannular plate shown in FIG. 6A.

FIG. 6E is a sectional view B-B of the cannular plate shown in FIG. 6D.

FIG. 7A is a perspective view of the hub plate of the first embodiment of the dispense tip cleaning apparatus shown in FIG. 1.

FIG. 7B is a side view of the hub plate shown in FIG. 7A.

FIG. 7C is a top view of the hub plate shown in FIG. 7A.

FIG. 7D is a sectional view C-C of the hub plate shown in FIG. 7C.

FIG. 7E is a side view of the hub plate shown in FIG. 7A.

FIG. 8A is a perspective view of the needle hub locator of the first embodiment of the dispense tip cleaning apparatus shown in FIG. 1.

FIG. 8B is a top view of the needle hub locator shown in FIG. 8A.

FIG. 8C is a side view of the needle hub locator shown in FIG. 8A.

FIG. 8D is a sectional view D-D of the needle hub locator shown in FIG. 8B.

FIG. 9 shows a perspective view of a further embodiment of the dispense tip cleaning apparatus of the present invention.

FIG. 10 shows an exploded view of the dispense tip cleaning apparatus shown in FIG. 9.

FIG. 11 shows a side view of a dispense tip prior to insertion into the dispense tip cleaning apparatus shown in FIG. 9.

FIG. 12 shows a side view of a dispense tip inserted into the dispense tip cleaning apparatus shown in FIG. 9.

FIG. 13 shows a side sectional view of a dispense tip prior to insertion into the dispense tip cleaning apparatus shown in FIG. 9.

FIG. 14 shows a side sectional view of a dispense tip inserted into the dispense tip cleaning apparatus shown in FIG. 9.

FIG. 15A shows rows of adhesive dispensed using the dispense tip cleaning apparatus of the present invention.

FIG. 15B shows rows of adhesive dispensed without cleaning the dispense tip.

FIG. 15C shows rows of adhesive dispensed by a prior art dispense tip cleaning apparatus with the dispense tip wiped clean between uses.

FIG. 16A shows an enlarged view of the end of the rows of adhesive that are shown in FIG. 15A.

FIG. 16B shows an enlarged view of the end of the rows of adhesive that are shown in FIG. 15B.

FIG. 16C shows an enlarged view of the end of the rows of adhesive that are shown in FIG. 15C.

FIGS. 17A-D show a dispense tip after repeated uses without cleaning at time intervals of 0, 15, 30 and 60 minutes, respectively.

FIGS. 18A-D show an embodiment of the dispense tip of the present invention after repeated uses at time intervals of 0, 15, 30 and 60 minutes, respectively.

### DETAILED DESCRIPTION OF THE INVENTION

The present invention is a dispense tip cleaning apparatus that prevents adhesive from building up on the tip of a dispense nozzle. The cleaning apparatus is especially intended for use in fully automated bead dispense systems where manual wipe of the dispense tip is not feasible. The apparatus maintains a clean dispense tip and insures that a precise volume of adhesive is repeatedly deposited at a selected location. The dispense tip cleaning apparatus cleans off residual adhesive from the end of a dispense tip so that consecutive dispenses duplicate the same dispense volume and pattern accurately and repeatedly.

The dispense tip cleaning apparatus uses a non-contact cleaning method that discharges compressed air and incorporates the Coanda effect to follow the boundary layer of the needle. As used herein, the term “Coanda effect” refers to a phenomenon discovered by Henri Coanda, a Romanian aircraft engineer, in 1930. It is the tendency of a jet of fluid emerging from an orifice to follow an adjacent flat or curved surface and to entrain fluid from the surroundings so that a region of lower pressure develops. In the dispense tip cleaning apparatus, when the compressed air is discharged, it tends to follow the curved surface of the nozzle—even to the point of bending around corners. As the air moves across the surface of the dispense tip, a certain amount of friction (called “skin friction”) occurs between the air and the surface, which tends to slow the moving air. This resistance to the flow of the air pulls the air towards the surface, causing it to displace any adhesive on the surface of the tip.

The dispense tip cleaning apparatus uses compressed air to clean the dispense tip rather than physically wiping the tip. The compressed air follows the cannular of the dispense tip (i.e., the outside cylindrical surface) without effecting or changing the position of the dispense tip and does not contaminate the dispense tip.

### Description of Components for One Embodiment

One embodiment of the dispense tip cleaning apparatus is formed from an assembly that includes a cannular plate, a hub plate, a needle hub locator, a dispense tip and a retainer that secures all of the other components in the cannular plate. The cannular plate has an opening extending from the top surface to a bottom wall with a stepped interior wall and an aperture in the bottom wall. The cannular plate houses the other components of the apparatus assembly. The hub plate has a cylindrically-shaped body with a passage extending between a flanged end and a distal end. The distal end of the hub plate has a lip extending inwardly so that the diameter of the opening at the flanged end is larger than the diameter of the opening at the distal end. The hub plate is inserted into the cannular plate and, in combination with the cannular plate, forms a low pressure annular chamber. The distal end of the hub plate and the bottom wall of the cannular plate form a small ring nozzle around the bottom aperture of the cannular plate.

The needle hub locator has a cylindrically-shaped body with an axial bore that is concentric with the passage in the hub plate. A plurality of apertures parallel to the axial bore extends through the body of the needle hub locator and allows air to flow between exterior and the low pressure chamber formed between the cannular plate and hub plate. The needle hub locator fits over the hub plate and is secured in the cannular plate by a retainer. The needle hub locator is used to position a dispense tip (also referred to herein as “the dispense nozzle”) that has a body and a needle extending therefrom. The dispense tip passes through the axial bore of the needle hub locator and the passage in the hub plate until the body of the dispense tip contacts the lip on the distal end of the hub plate and the needle extends through the bottom aperture of the cannular plate.

After the apparatus is assembled and installed, compressed air is connected through the aperture in the first section of the cannular plate. The compressed air flows into the annular chamber through the aperture in the first section of the cannular plate and is discharged through the ring nozzle that surrounds the dispense tip to prevent the adhesive from building-up.

### Description of Components for a Further Embodiment

A further embodiment of the dispense tip cleaning apparatus is formed from an assembly that includes a Coanda plate, a cap plate and, optionally, a gasket disposed therebetween. The Coanda plate is preferably cylindrically shaped with top and bottom surfaces, a perimeter wall with one or more apertures and an opening defined by an interior perimeter wall and extending between the top and bottom surfaces. A lip can extend inwardly from the interior perimeter wall of the Coanda plate near the bottom surface to form a discharge aperture. The cap plate has a top surface, a bottom surface, an exterior side wall and an annular member with an axial bore extending therethrough and an exterior wall extending from the bottom surface to a distal end. The cap plate also has a recessed portion in the bottom surface extending radially from the annular member to preferably a curved wall. The top surface of the Coanda plate corresponds to the bottom surface of the cap plate and the optional gasket is disposed therebetween to sealingly enclose the recessed portion of the cap plate. One or more threaded apertures can be correspondingly located in the Coanda plate and the cap plate for securing them together using threaded bolts or other fastening devices.

When the Coanda plate and cap plate are assembled, the annular member extends into the opening in the Coanda plate to form an annular chamber between the exterior wall of the annular member and the interior perimeter wall of the Coanda plate. The annular chamber extends from the top surface of the Coanda plate to a ring nozzle that is formed by the distal end of the annular member and the lip that extends from the interior wall. One or more passages connect the one or more apertures in the perimeter wall of the Coanda plate to the annular chamber via the recessed portion. The one or more apertures in the perimeter wall of the Coanda plate is/are connected to a source of pressurized air. The pressurized air enters the recessed portion of the cap plate and swirls around before it enters the annular chamber and is forced out at a high velocity through the ring nozzle which directs the flow of pressurized air towards the dispense tip.

The dispense tip cleaning apparatus can be mounted in a dispense tip cleaning station. A dispense tip selected for cleaning can be robotically inserted through the axial bore in the cap plate from the top surface side and the dispensing tip can be moved past the ring nozzle where it is contacted by the pressurized air that is discharged. As described above, the discharged pressurized air behaves according to the “Coanda effect” and moves along the surface of the dispense tip from the point of contact to the end. After a predetermined period of time, the dispense tip is removed from the cleaning apparatus and put back in service.

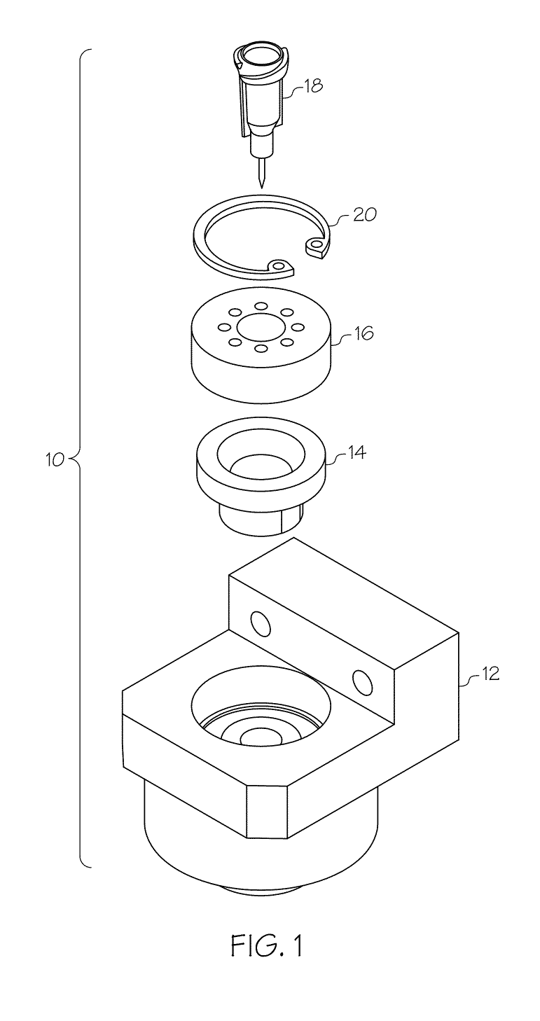

Referring now to the figures, FIG. 1 shows an exploded view of the assembly that forms the dispense tip cleaning apparatus 10 of the present invention. The dispense tip cleaning apparatus 10 includes a cannular plate 12, a hub plate 14, a needle hub locator 16, a dispense tip 18 and a retainer 20. The hub plate 14, needle hub locator 16 and dispense tip 18 are inserted in the cannular plate 12 and held in place by the retainer 20.

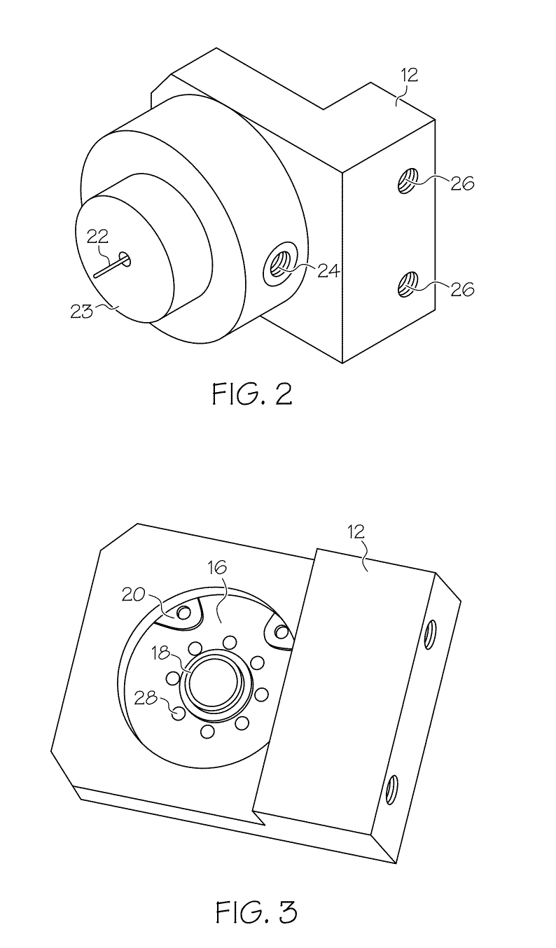

FIG. 2 is a bottom perspective view of the assembled dispense tip cleaning apparatus 10 shown in FIG. 1 with the dispense tip needle 22 extending through the bottom wall 23 of the cannular plate 12. An aperture 24 in the side wall of the cannular plate 12 is used to connect a compressed air. Two mounting apertures 26 are located in the base plate 30.

FIG. 3 is a top, perspective view of the assembled dispense tip cleaning apparatus 10 shown in FIG. 1. The needle hub locator 16 and the dispense tip 18 are installed in the cannular plate 12 and secured in place by the retainer 20. A plurality of apertures 28 in the needle hub locator 16 extend around the dispense tip 18.

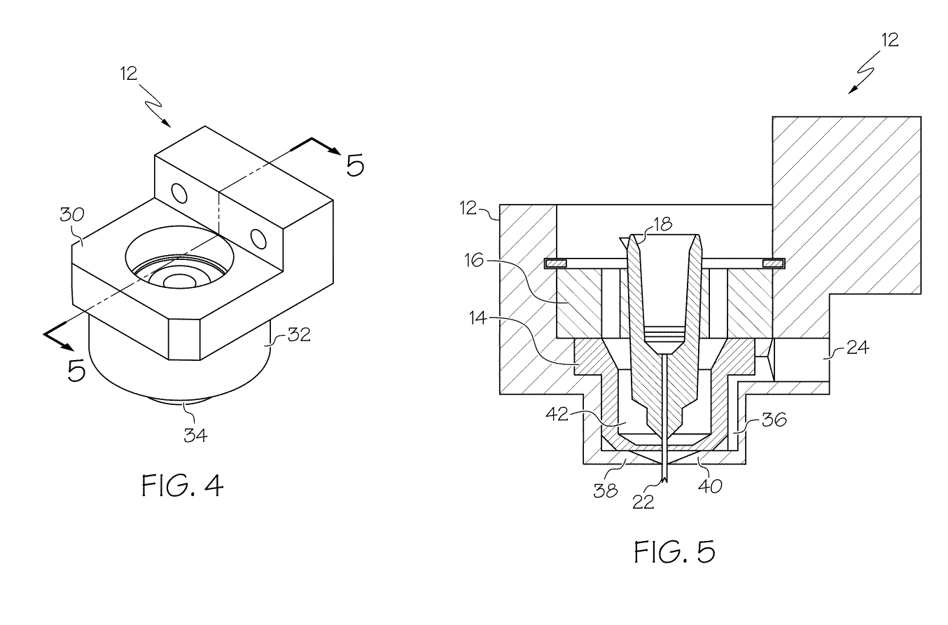

FIG. 4 is a perspective top view of the assembled dispense tip cleaning apparatus 10 shown in FIG. 1. The cannular plate 12 includes a base plate 30, a first section 32 and a second section 34. FIG. 5 is a sectional view A-A from FIG. 4 and shows aperture 24 through which compressed air flows into an annular chamber 36 and is then throttled through a small ring nozzle 38 at high velocity. The primary air stream adheres to the Coanda profile which directs it down the angled surface 40 of the cannular plate 12. A low pressure area is created at the center 42 of the annular chamber 36, which induces a high volume flow of surrounding air into the primary air stream. This creates a conical 360° ring of high velocity stream air that uniformly wipes the surface of the needle 22.

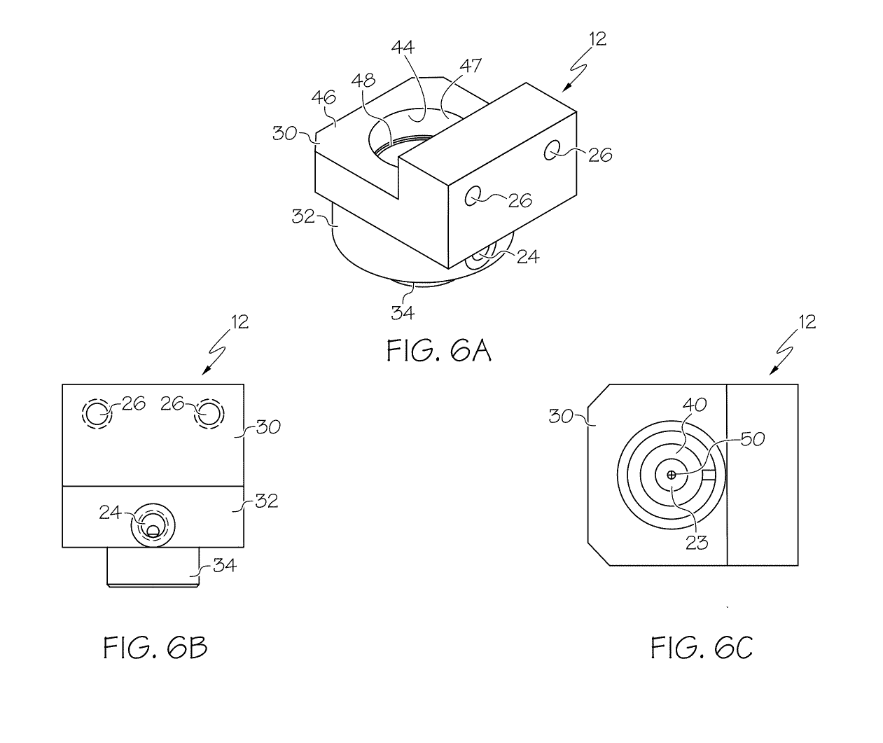

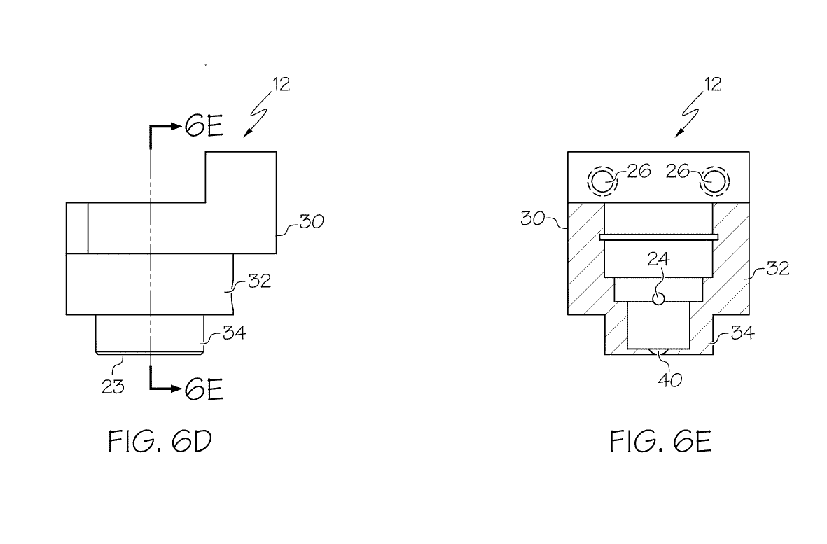

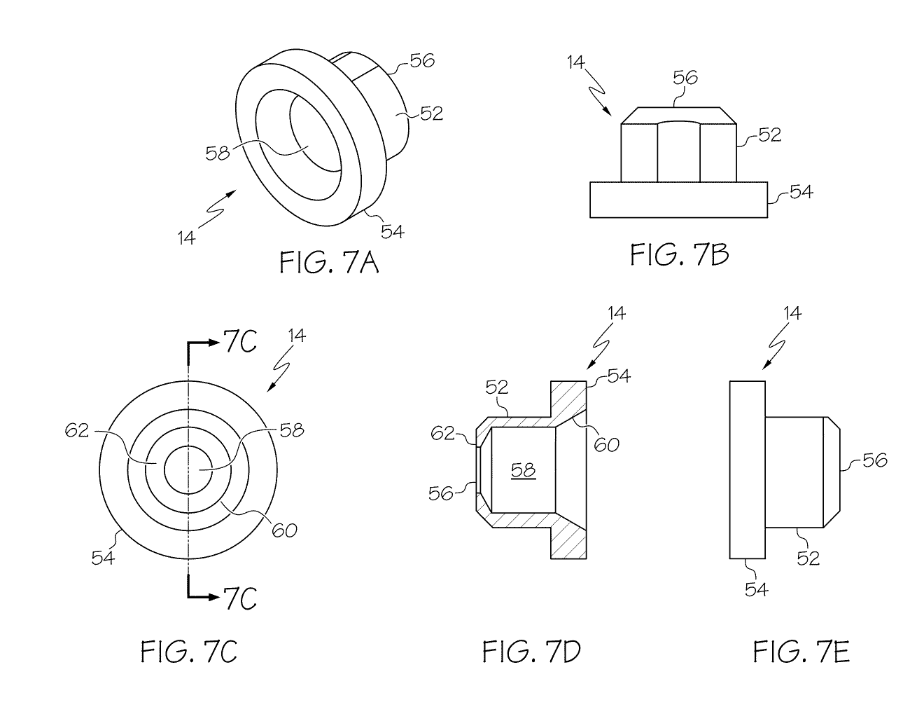

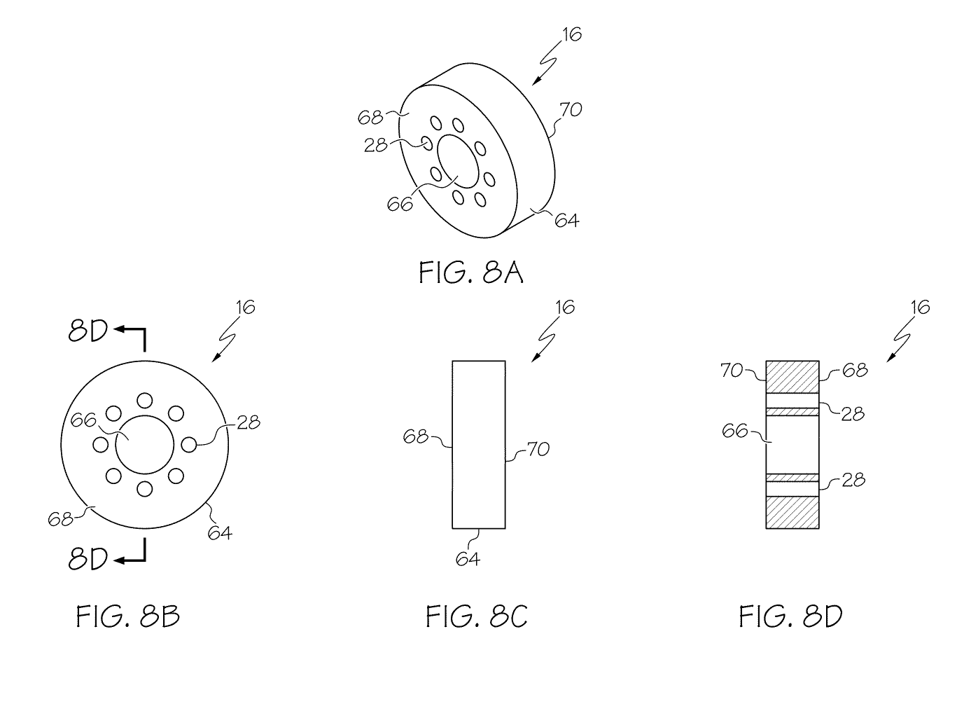

FIGS. 6A-E show different views of the cannular plate 12. FIG. 6C shows the opening 44 in the cannular plate 12 that extends downwardly from the top surface 46. The opening 44 has an interior side wall 47 that defines the interior. A groove 48 in the interior side wall 47 is used for securing the retainer 20 in the cannular plate 12 (see FIG. 3). FIG. 6B is an end view of the cannular plate 12 and it illustrates the stepped construction of the cannular plate 12. FIG. 6C is a top view of the cannular plate 12 and it shows how the diameter decreases as the opening 44 extends from the top surface 46 to the bottom wall 23. It also shows the aperture 50 in the bottom wall 23. FIG. 6D is a side view of the cannular plate 12. FIG. 6E shows section B-B from FIG. 6D and it illustrates the construction of the opening 44 of the cannular plate 12.

FIGS. 7A-E show different views of the hub plate 14. The hub plate 14 has a cylindrical side wall 52 extending between a flanged end 54 and a distal end 56 to form a passage 58 therebetween. The flanged end 54 has a beveled interior edge 60 and the distal end 56 has a lip 62 that extends inwardly. FIG. 7D shows section C-C from FIG. 7C and it illustrates the construction of the beveled edge 60 on the flanged end 54 and the lip 62 extending inwardly on the distal end 56.

FIGS. 8A-D show the needle hub locator 16. FIG. 8A shows the cylindrically-shaped body 64 with an axial bore 66 and a plurality of apertures 28 extending from a first side 68 to a second side 70. FIG. 8D shows section C-C from FIG. 8B and it illustrates the construction of the axial bore 66 and apertures 28.

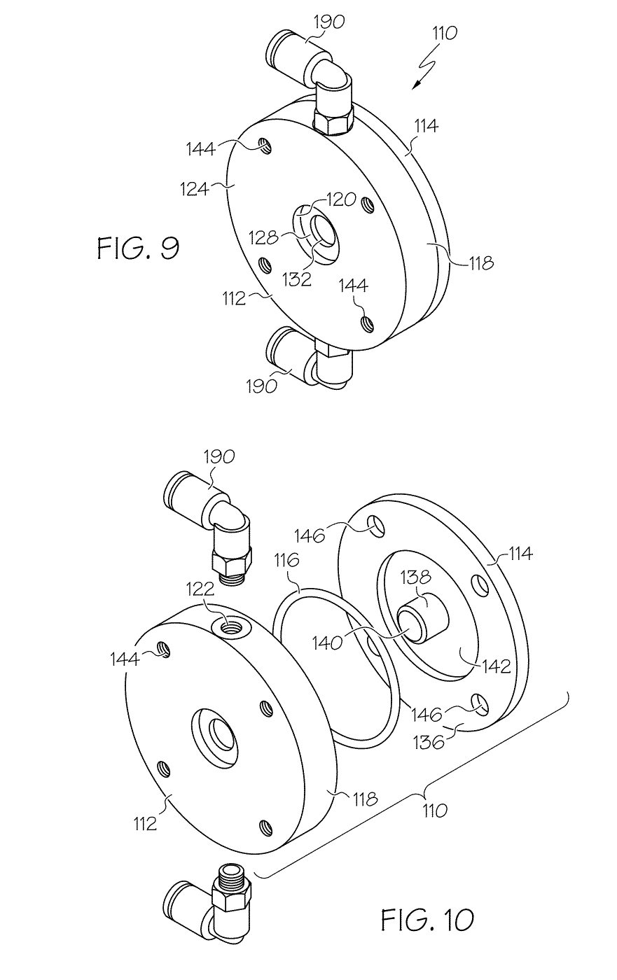

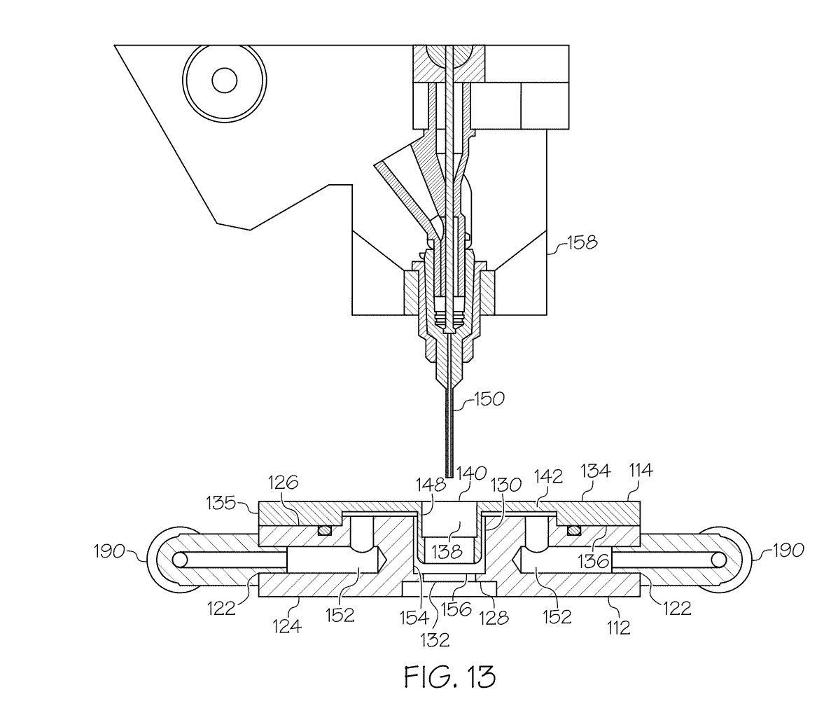

A further embodiment of the dispense tip cleaning apparatus 110 of the present invention is shown in FIGS. 9-14. FIGS. 9 and 10 show a perspective side view and an exploded view, respectively, of the dispense tip cleaning apparatus 110 that includes a Coanda plate 112 attached to a cap plate 114 with an optional gasket 116 disposed therebetween. The Coanda plate 112 has a perimeter wall 118 with one or more threaded apertures 122 that extends between a substantially flat bottom surface 124 and a top surface 126 (see FIG. 13). Elbow fittings 190 are attached to the threaded apertures 124 for connection to a source of high pressure air. A central opening 120 in the middle of the Coanda plate 112 is defined by a side wall 130 and extends between the top surface 126 and the bottom surface 124. The opening 120 has a lip 128 that extends inwardly from the side wall 130 to form an aperture 132.

FIG. 10 shows an exploded view of the dispense tip cleaning apparatus 110 shown in FIG. 9. The cap plate 114 has an exterior side wall 135 extending between a top surface 134 and a bottom surface 136 (see FIG. 13). An annular member 138 with an axial bore 140 extends from the bottom surface 136 and a recessed portion 142 extends radially from the annular member 138 on the bottom surface 136 of the cap plate 114. When the Coanda plate 112 is attached to the cap plate 114, the recessed portion 142 forms an enclosed space. A plurality of threaded apertures 144 in the Coanda plate 112 and a plurality of threaded apertures 146 in the cap plate 114 are correspondingly located and are used to secure the cap plate 1140 the Coanda plate 112, preferably with bolts or similar fastening devices (not shown).

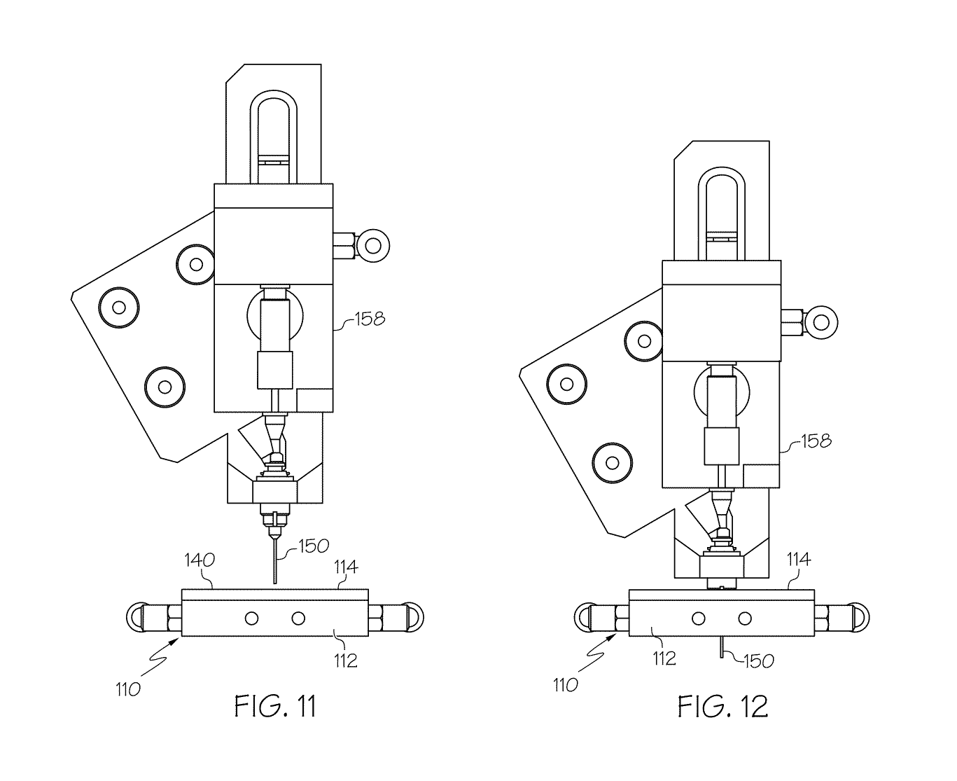

FIG. 11 shows a dispense tip 150 prior to insertion into the dispense tip cleaning apparatus 110 shown in FIG. 9. The dispense tip 150 passes through the axial bore 140 in the cap plate 114 and the aperture 132 in the Coanda plate 112 as shown in FIG. 12. Typically, the dispense tip 150 is part of a robotically controlled adhesive dispensing system that is used in a manufacturing process. After a predetermined number of hours in operation, the dispensing tip 150 is cleaned using the dispense tip cleaning apparatus 110.

FIG. 13 shows a side sectional view of the dispense tip 150 prior to insertion into the dispense tip cleaning apparatus 110. The apertures 122 of the Coanda plate 112 are in communication with the recessed portion of the cap plate 114 through a passage 152. When the annular member 138 of the cap plate 114 is inserted into the opening 120 in the Coanda plate 112, an annular chamber 148 is formed between the annular member 138 and the side wall 130 of the opening 120 and a ring nozzle 154 is formed between the lip 128 and the distal end 156 of the annular member 138.

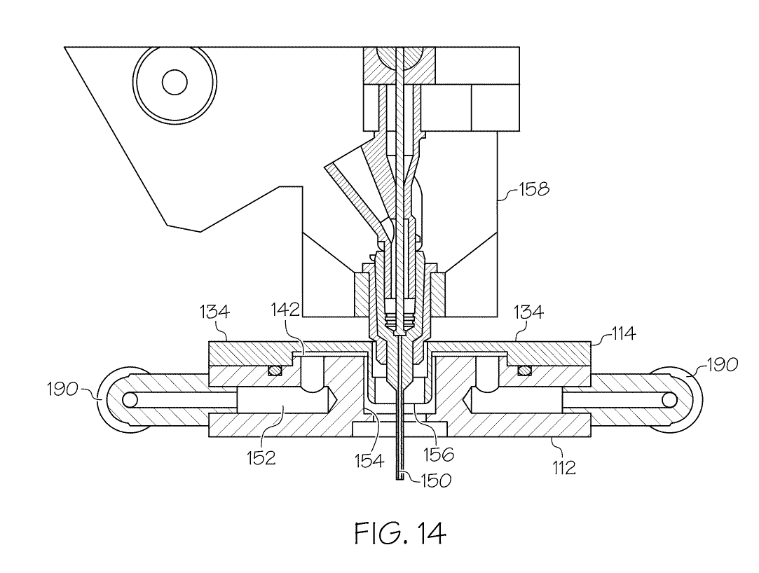

FIG. 14 shows a side sectional view of the dispense tip 150 after it is inserted into the dispense tip cleaning apparatus 110 shown. The dispense tip assembly 158 is constructed so that it fits into the axial bore 140 of the cap plate 114 and also contacts the top surface 134 of the cap plate 114. After the dispense tip 150 is inserted in the dispense tip cleaning apparatus 110, high pressure air enters through elbow fittings 190, passes through passage 152 to the recessed portion 142 and into annular chamber 148 before being discharged around the dispense tip 150 through ring nozzle 154. As discussed in more detail above, the high pressure air flows around the dispense tip 150 according to the Coanda effect and removes any adhesive on the dispense tip 150 that may have accumulated during operation.

### EXAMPLES

The examples set forth below serve to provide further appreciation of the invention but are not meant in any way to restrict the scope of the invention.

### Example 1

For this example, three comparative tests were conducted using; (1) the dispense tip cleaning apparatus of the present invention; (2) a dispense tip without any cleaning; (3) and a dispense tip needle that was manually wiped with a sponge after each use. Prior to conducting the tests, the dispense tips and lines were purged and cleaned to remove adhesive and any debris that may affect the operation of the dispense tip. A plurality of beads of adhesive was dispensed on a plate for each method being tested. The “start of line” was visually compared for repeatability and consistency.

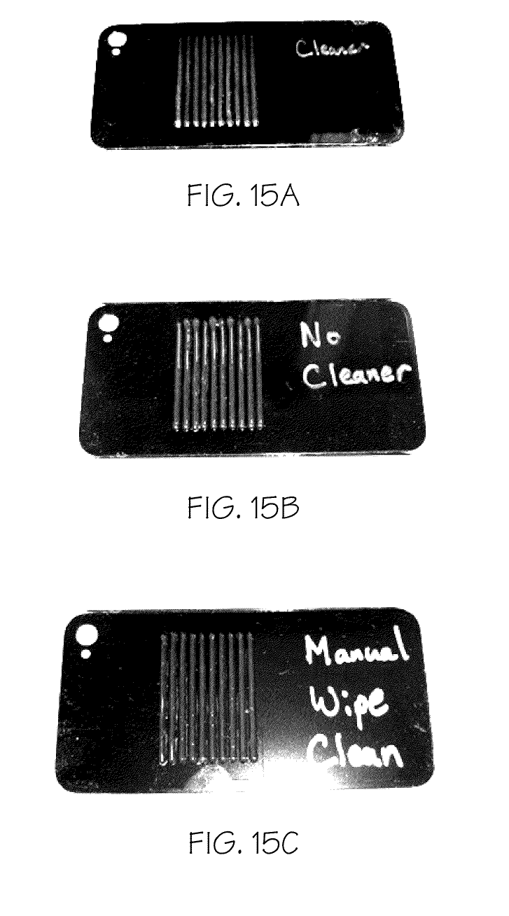

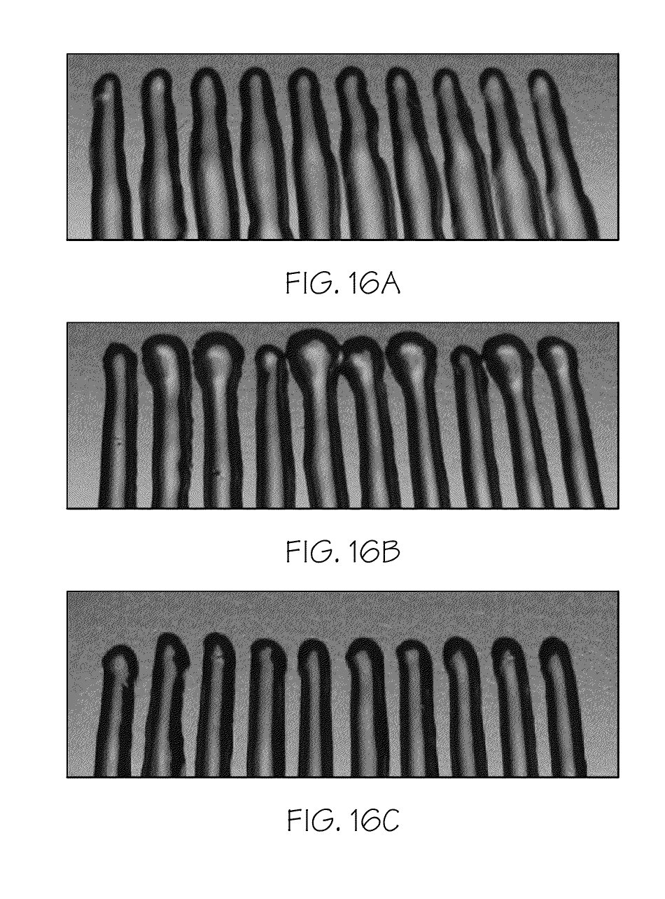

FIGS. 15A-C show the comparative test results for adhesives that were dispensed using the cleaning apparatus of the present invention (FIG. 15A), no cleaning device (FIG. 15B) and manual wiping of the needle after each use (FIG. 15C). The ends of the lines of adhesive are shown in more detail in FIGS. 16A-C, which correspond to FIGS. 15A-C, respectively. The results for the dispense tip cleaning apparatus of the present invention are shown in FIG. 16A and they are clearly an improvement over no cleaning at all shown in FIG. 16B and as good, if not better (i.e., more consistent) than the manual cleaning results shown in FIG. 16C.

### Example 2

For this example, needle build up over time tests were conducted. The tests compared the amount of adhesive that built up on the dispense needle when the dispense tip cleaning apparatus of the present invention was used versus when it was not used. The dispense tip and lines were cleaned as described in Example 1. The dispense was set on repeat purge and the needle tip was monitored over time. The “no cleaning” tests had a 5 second purge and a 5 second wait. The tests using the cleaning apparatus of the present invention had a 5 second purge, a 2 second cleaning and a 3 second wait. It was observed that the “no cleaning” tests had build-up over time and resulted in the dispense contact area on a substrate to become larger and wider over time (from T=0 to 60 min). In contrast, the tests using the cleaning apparatus of the present invention had essentially the same level of cleaning over time (from T=0 to 60 min)

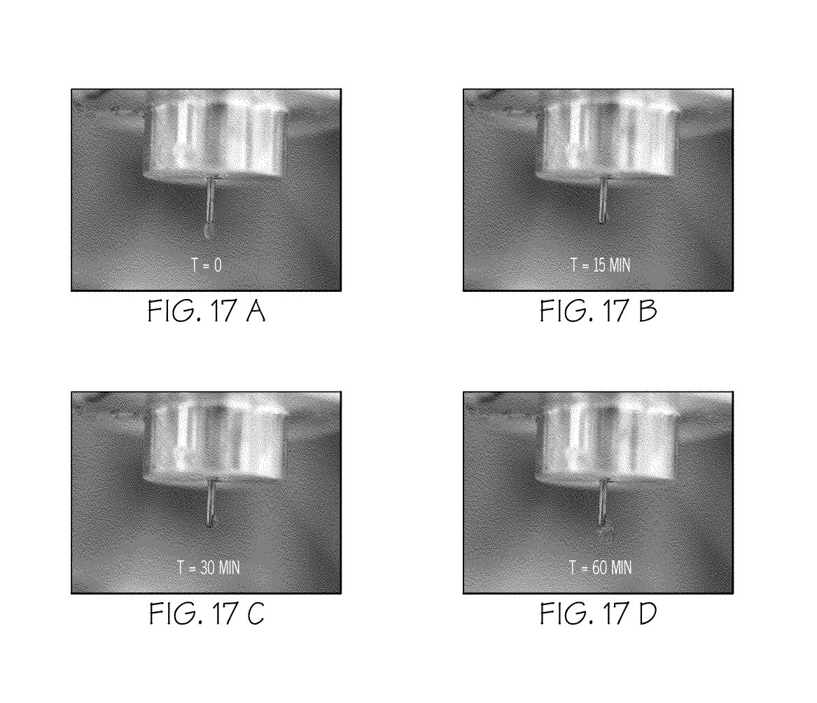

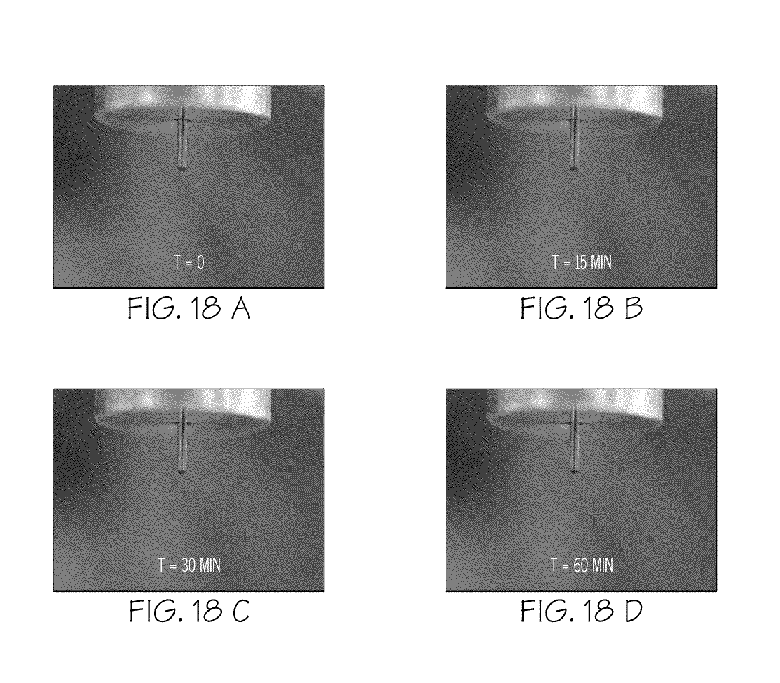

FIGS. 17A-D are photographs of the “no cleaning” dispense tip after repeated uses at time intervals of 0, 15, 30 and 60 minutes, respectively. FIGS. 18A-D are photographs of the dispense tip of the present invention after repeated uses at time intervals of 0, 15, 30 and 60 minutes, respectively. The “no cleaning” dispense tip shows (FIGS. 17A-D) a build-up of adhesive on the tip that increases over time. In contrast, the dispense tip that used the cleaning apparatus of the present invention showed no discernable build-up of adhesive at the tip.

Thus, while there have been described the preferred embodiments of the present invention, those skilled in the art will realize than other embodiments can be made without departing from the spirit of the invention, and it is intended to include all such further modifications and changes as come within the true scope of the claims set forth herein.

What is claimed is:

1. A dispense tip cleaning apparatus comprising:
a Coanda plate having at least one aperture therein and a central opening in communication with said aperture;
a cap plate attached to said Coanda plate and having an annular member extending through said central opening forming an annular chamber therebetween, said annular member adapted to receive a dispense tip;
said annular chamber being in fluid communication with said at least one aperture of said Coanda plate so as to transmit compressed air into said annular chamber and to create a low pressure area at the central opening inducing a high flow of surrounding air into the compressed air stream creating a 360 degree ring of air that uniformly cleans said dispense tip.

2. The dispense tip cleaning apparatus according to claim 1 wherein the Coanda plate has a perimetrical wall with a top surface and a bottom surface with the central opening extending therebetween, wherein the central opening is defined by an interior wall; and
the cap plate has a top surface, a bottom surface, an exterior side wall and wherein the annular member has an axial bore extending from the bottom surface to a distal end, wherein the top surface of the Coanda plate is disposed opposite the bottom surface of the cap plate and the annular member is positioned in the opening in the Coanda plate and forms the annular chamber bounded by the interior wall of the Coanda plate.

3. The dispense tip cleaning apparatus according to claim 2 further comprising a gasket disposed between the bottom surface of the cap plate and the top surface of the Coanda plate.

4. The dispense tip cleaning apparatus according to claim 2, wherein the bottom surface of the cap plate has a recessed portion extending radially from the annular member.

5. The dispense tip cleaning apparatus according to claim 2, wherein the at least one aperture in the perimetrical wall of the Coanda plate is threaded.

6. The dispense tip cleaning apparatus according to claim 2, wherein a lip extends inwardly from the interior wall of the Coanda plate and forms a discharge aperture.

7. The dispense tip cleaning apparatus according to claim 6, wherein the distal end of the annular member and the discharge aperture form a ring nozzle.

8. The dispense tip cleaning apparatus according to claim 2, wherein the perimetrical wall of the Coanda plate has two apertures.

9. The dispense tip cleaning apparatus according to claim 2, wherein the Coanda plate has one or more apertures and the hub plate has one or more apertures, wherein the apertures in the Coanda plate are aligned with the apertures in the cap plate and one or more fastening devices secure the Coanda plate to the cap plate.

10. The dispense tip cleaning apparatus according to claim 4, wherein a passage extends from each aperture in the perimetrical wall to the top surface of the Coanda plate.

11. The dispense tip cleaning apparatus according to claim 10, wherein the annular chamber is in fluidic communication with the at least one aperture in the perimetrical wall of the Coanda plate via the recessed portion.

12. A dispense tip cleaning apparatus comprising:
a cannular plate having a top surface and an opening therein extending to a bottom wall with a bottom aperture, wherein the opening is defined by an interior wall with an aperture;
a hub plate having opposing ends and a passage extending therebetween, wherein the hub plate is positioned in the opening in the cannular plate and forms a chamber therebetween;
a needle hub locator having a cylindrically shaped body with an axial bore, wherein the needle hub locator is secured in the opening in the cannular plate and on top of the hub plate; and
a dispense tip having an elongate body and a hollow needle extending from an end;
wherein the dispense tip is positioned in the axial bore of the needle hub locator and the passage in the hub plate and the hollow needle extends through the bottom aperture in the cannular plate, and wherein the aperture in the cannular plate is adapted to transmit compressed air into the chamber.

13. The dispense tip cleaning apparatus according to claim 12, wherein hub comprises a distal end with an inwardly extending lip.

14. The dispense tip cleaning apparatus according to claim 12, wherein the hub has a beveled flanged end.

15. The dispense tip cleaning apparatus according to claim 12, wherein hub has a distal end that together with the bottom wall of the cannular plate form a ring nozzle around the bottom aperture in the cannular plate, and wherein the compressed air passes from the chamber and through the ring nozzle.

16. The dispense tip cleaning apparatus according to claim 12, wherein the needle hub locator has a cylindrically shaped body with a plurality of apertures extending between the first and second sides.

17. The dispense tip cleaning apparatus according to claim 16, wherein the plurality of apertures in the needle hub locator is substantially parallel to the axial bore.

18. The dispense tip cleaning apparatus according to claim 12, wherein the opening in the cannular plate has a first diameter at the top surface, a second diameter proximate the top surface and the bottom wall and a third diameter at the bottom wall, wherein the first diameter is greater than the second diameter and the second diameter is greater than the third diameter.

19. The dispense tip cleaning apparatus according to claim 18, wherein the hub plate has a flanged end with a diameter less than the first diameter and greater than the second diameter of the opening in the cannular plate.

20. The dispense tip cleaning apparatus according to claim 12 further comprising a retainer that secures the needle hub locator in the cannular plate.

21. The dispense tip cleaning apparatus according to claim 20, wherein the interior wall of the body of the cannular plate has a groove, and wherein the retainer engages the groove.

22. The dispense tip cleaning apparatus according to claim 21, wherein the retainer has a flexible open ring structure.
